(19) United States
(12) Patent Application Publication
(10) Pub. No.: US 2017/0068212 A1
(43) Pub. Date: Mar. 9, 2017

(54) IMAGE FORMING APPARATUS

(71) Applicant: CANON KABUSHIKI KAISHA, Tokyo (JP)

(72) Inventors: Ryosuke Nanai, Tokyo (JP); Tetsuhiro Yoshimoto, Tokyo (JP)

(21) Appl. No.: 15/251,296

(22) Filed: Aug. 30, 2016

(30) Foreign Application Priority Data
Sep. 7, 2015 (JP) 2015-176093

(51) Int. Cl. G03G 15/20

(52) U.S. Cl. CPC G03G 21/1889; G03G 15/2078; G03G 15/5004; G03G 21/1685; G03G 21/1892; G03G 2221/1639; G03G 2221/1823; G03G 2221/1838; G03G 2221/1892

(57) ABSTRACT

An image forming apparatus comprises a fixing device comprising a heater for heating a sheet on which an image is formed and a non-volatile memory in which characteristic information of the heater is stored. The fixing device is replaceable. In a case where the fixing device is replaced, the image forming apparatus starts to supply power to the heater before completing to read the characteristic information from the fixing device replaced. Due to this, the image forming apparatus can promptly heat the heater of the fixing device than before.

### BACKGROUND OF THE INVENTION

Field of the Invention

The present disclosure relates to an image forming apparatus for forming images on a sheet, such as a printer, a copying machine, a multifunction peripheral and the like.

Description of the Related Art

An electrophotographic image forming apparatus performs image formation by forming a toner image on a photoreceptor and transferring the toner image to a sheet. The image forming apparatus is provided with a fixing device for fixing the toner image on the sheet by heating and pressurizing the toner image. To heat the toner image, the fixing device comprises a resistance heater as a heat source. Due to variation in resistance value, the resistance heaters have individual differences in heating value. In a conventional image forming apparatus, the resistance value of the resistance heater is detected by feeding a small current to the fixing device before starting to heat the resistance heater. Then, heating of the resistance heater is started with power according to a detection result. Japanese Patent Application Laid-open No. 2011-197372 discloses a fixing device including a non-volatile memory which stores characteristic information relating to the fixing device such as the resistance value of the resistance heater. The image forming unit obtains the characteristic information from the non-volatile memory before starting to heat the resistance heater. Then, according to the characteristic information obtained, the resistance heater of the fixing device is heated.

In a case where the fixing device is heated after obtaining the characteristic information stored in the fixing device, it is not necessary to detect the resistance value of the resistance heater before starting to heat the resistance heater. In terms of cost, inexpensive non-volatile memory, transfer rate of which is about 100 kbps, is used as the non-volatile memory provided in the fixing device. Thereby, in a case where the resistance heater is started to heat after completing to read the characteristic information, by the time the resistance heater is started to heat, standby time is caused, which hampers rapid heating of the fixing device. Thereby, an image forming apparatus capable of heating the heater of the fixing device comprising a storage unit which stores the characteristic information more rapidly than before is desired.

### SUMMARY OF THE INVENTION

According to the present disclosure, there is provided an image forming apparatus to which a fixing device, comprising a heater and a memory for storing information relating to the heater, is detachably mounted, the image forming apparatus comprising: a storage unit configured to store the information relating to the heater obtained from the fixing device; an image forming unit configured to form an image on a sheet; and a controller for controlling power to be supplied to the heater based on the information stored in the storage unit to cause the fixing device to fix the image on the sheet, wherein the controller detects replacement of the fixing device, wherein, in a case where replacement of the fixing device is detected, the controller reads information stored in the memory of the fixing device replaced to update the information stored in the storage unit, and wherein, in a case where replacement of the fixing device is detected, the controller starts to supply power to the heater before completing to read the information from the memory of the fixing device replaced.

Further features of the present invention will become apparent from the following description of exemplary embodiments (with reference to the attached drawings).

### BRIEF DESCRIPTION OF THE DRAWINGS

FIG. 1 is a schematic configuration diagram of an image forming apparatus.

FIGS. 2A, 2B, and 2C are explanatory diagrams of the fixing device.

FIG. 3 is an explanatory diagram of a main control unit.

FIG. 4 is an explanatory diagram of a power energization control unit.

FIG. 5 is an explanatory diagram of a zero cross detection unit.

FIG. 6 is a timing chart when supplying power to a heater.

FIG. 7 is an explanatory diagram configured to detect attachment/detachment of the fixing device.

FIG. 8 is a flow chart showing temperature control processing.

### DESCRIPTION OF THE EMBODIMENTS

In the following, embodiments are described in detail with reference to the accompanying drawings.

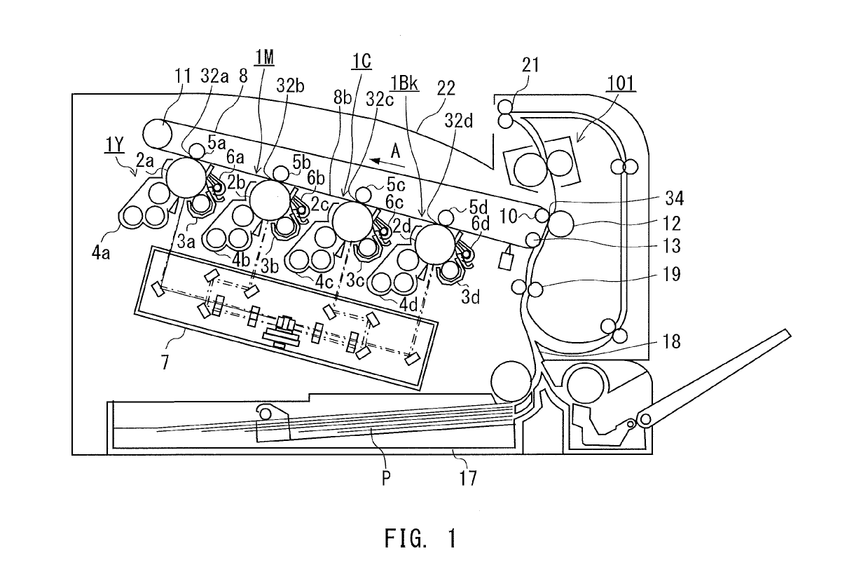

FIG. 1 is a schematic configuration diagram of a tandem type color image forming apparatus. The image forming apparatus is provided with four image forming units including an image forming unit 1Y for forming an image of yellow, an image forming unit 1M for forming an image of magenta, an image forming unit 1C for forming an image of cyan, and an image forming unit 1Bk for forming an image of black. These four image forming units, 1Y, 1M, 1C, and 1Bk are arranged in a row at regular intervals.

A description is provided with regard to a configuration of the image forming unit 1Y. The configuration of the image forming units 1M, 1C, and 1Bk is the same as that of the image forming unit 1Y so that the description is omitted. The image forming unit 1Y comprises a drum type electrophotographic photoreceptor (hereinafter referred to as “photosensitive drum”) 2a as an image carrier. The image unit 1Y comprises a primary charger 3a, a developing unit 4a, a transfer roller 5a, and a drum cleaner 6a, which are provided around the photosensitive drum 2a. The image forming unit 1Y is an example of a cartridge member in which the photosensitive drum 2a, the primary charger 3a, the developing unit 4a, the transfer roller 5a, and the drum cleaner 6a are integrated, which is attachable/detachable to/from the image forming apparatus. The cartridge member is a member which is attachable/detachable to/from the image forming apparatus.

The photosensitive drum 2a is a negatively charged OPC photoreceptor, which has a photoconductive layer on an aluminum drum base. The photosensitive drum 2a is rotationally driven at predetermined processing speed by a driving device (not shown). The primary charger 3a uniformly charges a surface of the photosensitive drum 2a by a charging bias to a predetermined negative potential.

A laser exposure unit 7 is provided below between the primary charger 3a and the developing unit 4a. The laser exposure unit 7 is comprised of a light emitting unit which emits light corresponding to an image data, a polygon lens, a reflection mirror and the like. The laser exposure unit 7 forms an electrostatic latent image corresponding to the image data of each color on a surface of each photosensitive drum 2a, 2b, 2c, and 2d by performing exposure on each photosensitive drum 2a, 2b, 2c, and 2d. The developing units 4a, 4b, 4c, and 4d respectively stores toner of yellow, cyan, magenta, and black in order. By adhering the toner of each color to the electrostatic latent image formed on each photosensitive drum 2a, 2b, 2c, and 2d, the toner image is developed (visualized).

The transfer roller 5a is arranged so that it is brought into contact with the photosensitive drum 2a through an intermediate transfer belt 8 in a primary transfer unit 32a. The toner images formed on the photosensitive drums 2a, 2b, 2c, and 2d are transferred to the intermediate transfer belt 8 so as to sequentially overlap each other. The drum cleaners 6a, 6b, 6c, and 6d, consisting of a cleaning blade and the like, scrape toner remaining on the photosensitive drums 2a, 2b, 2c, and 2d after the first transfer for cleaning.

The intermediate transfer belt 8 is arranged on an upper surface of the photosensitive drums 2a, 2b, 2c, and 2d. Further, the intermediate transfer belt 8 is stretched by a secondary transfer opposed roller 10, a tension roller 11, and an intermediate transfer drive roller 13. The intermediate transfer belt 8 is made of polycarbonate and dielectric resin such as polyethylene terephthalate resin film, polyvinyl fluoride vinylidene resin film. The secondary transfer opposed roller 10 is arranged so that it is brought into contact with the secondary transfer roller 12 through the intermediate transfer belt 8 in a secondary transfer unit 34. The toner image transferred to the intermediate transfer belt 8 is transferred to a sheet P conveyed from a sheet feeding unit 17 in the secondary transfer unit 34.

The sheet P is stored in the sheet feeding unit 17 arranged below the image forming units 1Y, 1M, 1C and 1Bk. The sheet P is conveyed to the secondary transfer unit 34 by a conveying roller 19 via a conveying path 18. The toner image is transferred to the sheet P in the secondary transfer unit 34. Thereafter, the toner image is fixed on the sheet P by a fixing device 101. By heating and pressurizing the sheet P, the fixing device 101 fixes the toner image on the sheet P. In this manner, the image is formed on the sheet P. Then, the sheet P is delivered from the image forming apparatus by a delivery roller 21.

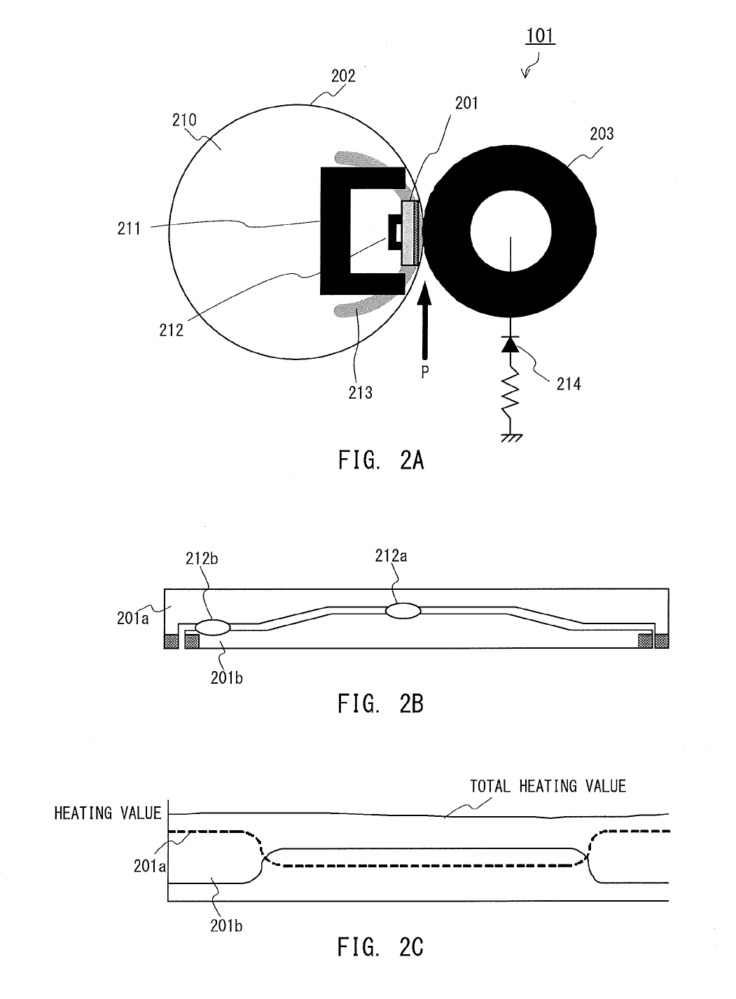

FIGS. 2A, 2B, and 2C are explanatory diagrams of the fixing device 101.

FIG. 2A shows a configuration of the fixing device 101. The fixing device 101 comprises a heating member 210 for heating the sheet P and a pressurizing roller 203 for pressurizing the sheet P interposed between the heating member 210 and the pressurizing roller 203. The heating member 210 comprises a heater 201, a fixing film 202, a sheet metal 211, a temperature detection unit 212, and a holder 213. The heater 201 and the temperature detection unit 212 are mounted to the holder 213.

The pressurizing roller 203 is connected to a self-bias section 214. With the self-bias section 214, the pressurizing roller 203 removes negative charges from the sheet P. The pressurizing roller 203 rotates while being energized to the heating member 210 side. The pressurizing roller 203, hardness of which is about 60 degrees, frictionally drives the fixing film 202.

The heater 201 is a resistance heater comprising a ceramic substrate on which heating patterns 201a and 201b as shown in FIG. 2B are printed. For example, the heating patterns 201a and 201b of the heater 201 are formed by a heating member having high responsiveness such as that allows temperature rise of about 50° C. in one second. FIG. 2C shows heat generation characteristics of the heater 201. At a center part of the heater 201, heating value by the heating pattern 201b is high. At an end part of the heater 201, the heating value by the heating pattern 201a is high. The heating patterns 201a and 201b are formed such that the heating value of the heater 201 is entirely constant.

The fixing film 202 is a film-like member, the base material of which is metal. A rubber layer of about 300 μm is formed on a surface of the fixing film 202. Further, fluorine surface treatment is applied to the fixing film 202. The fixing film 202 includes the heater 201, the temperature detection unit 212, the holder 213, and the sheet metal 211. The fixing film 202, with extremely low heat capacity, is configured to transfer the heat of the heater 201 through a nip portion which contacts the pressurizing roller 203.

The sheet metal 211 is a c-shaped member which energizes the fixing film 202 to the pressurizing roller 203 side. For example, the sheet metal 211 energizes the fixing film 202 with a force of 180 N.

The temperature detection unit 211 is a thermistor for example, a sensor for detecting the temperature of the heater 201. As shown in FIG. 2B, the temperature detection unit 212 is arranged at the center part and the end part of the heater 201. A main temperature detection unit 212a arranged at the center part of the heater 201 detects the temperature for controlling the temperature of the heater 201. A sub temperature detection unit 212b arranged at the end part of the heater 201 detects, when small-sized sheet P and the like passes through, the temperature of a part where the sheet P does not pass through. With the sub temperature detection unit 212b, it is possible to detect the temperature rise of the part where the sheet P does not pass through.

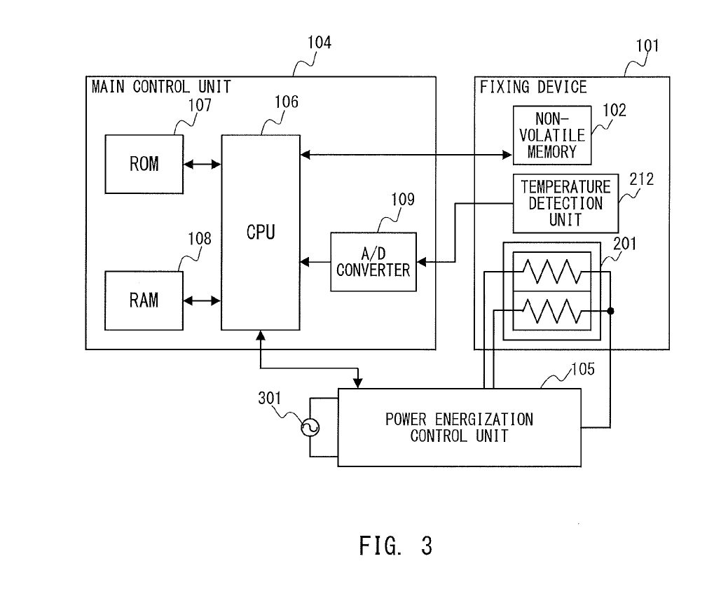

FIG. 3 is an explanatory diagram of a main control unit 104. The main control unit 104 is provided in the image forming apparatus. The main control unit 104 controls image forming processing performed on the sheet P by controlling operation of each unit in the image forming apparatus. In the present embodiment, among various functions of the main control unit 104, a function which performs temperature control of the fixing device 101 is described. Description with regard to the rest of the functions is omitted. To perform the temperature control of the fixing device 101, the main control unit 104 is connected to the fixing device 101 and a power energization control unit 105.

In addition to the heater 201 and the temperature detection unit 212, the fixing device 101 comprises a non-volatile memory 102. The non-volatile memory 102 stores the characteristic information representing the characteristic of the fixing device 101 required for controlling the fixing device 101. For example, the characteristic information includes resistance value or the temperature characteristic of the heater 201. Due to variation in the resistance value, the heater 201 has an individual difference in heating value. The characteristic information is the information to suppress the variation.

According to the characteristic information obtained from the fixing device 101 and the temperature of the heater 201 detected by the temperature detection unit 212, the main control unit 104 controls the power energization control unit 105 to perform power energization control of the heater 201. Through the power energization control, the heating value of the heater 201 is controlled so that it generates heat at predetermined temperature. The main control unit 104 comprises a central processing unit (CPU) 106, a read only memory (ROM) 107, a random access memory (RAM) 108, and an A/D converter 109.

The CPU 106 performs various processing relating to the image formation by reading a computer program from the ROM 107 and executes the computer program using the RAM 108 as a work area. In the present embodiment, by performing power energization control of the heater 201 as mentioned, the CPU 106 adjusts the temperature of the heater 201. The CPU 106 obtains the characteristic information from the non-volatile memory 102 through serial communication. Based on the characteristic information, the CPU 106 updates a power energization ratio setting value which instructs power which is supplied to the fixing device 101 by the power energization control unit 105. The CPU 106 transmits power energization control signal including the updated power energization ratio setting value to the power energization control unit 105. The power energization control unit 105 adjusts the heating value of the heater 201 according to the power energization control signal. The power energization ratio setting value is a value stored in advance in the RAM 107 and the like.

The A/D converter 109 obtains the detection result of the temperature of the heater 201 detected by the temperature detection unit 212 of the fixing device 101. Then, the A/D converter 109 performs A/D conversion of the detection result obtained. The CPU 106 refers a temperature conversion table showing relation of the detection result of the temperature detected by the temperature detection unit 212 and the temperature of the heater 201. Then, the CPU 106 confirms the temperature of the heater 201 from the detection result detected by the temperature detection unit 212 which is A/D converted. It is noted that the temperature conversion table is stored in advance in the ROM 107, the RAM 108, or the non-volatile memory 102.

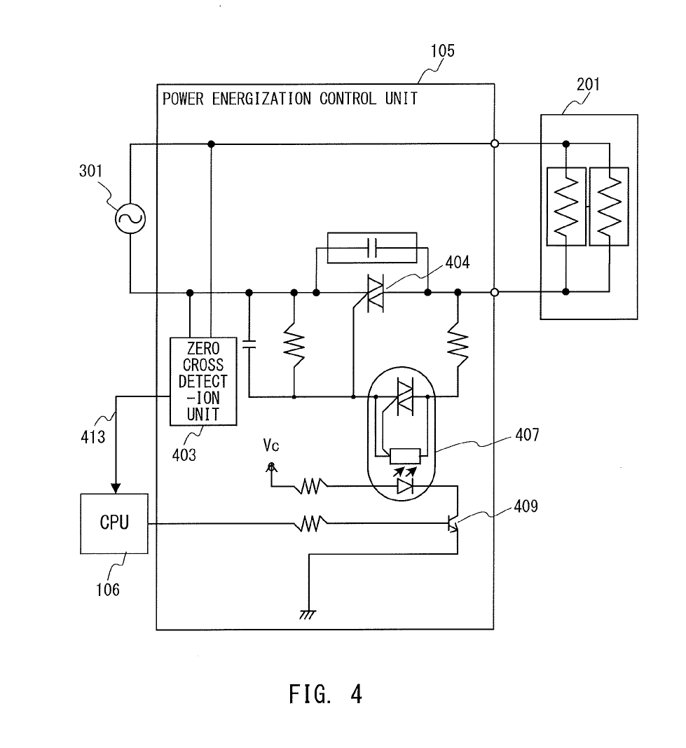

FIG. 4 is an explanatory diagram of the power energization control unit 105. The power energization control unit 105 comprises a zero cross detection unit 403, a photo triac coupler 407, a transistor 409, and a triac 404. According to the power energization control signal which is input from the CPU 106, the power energization control unit 105 supplies power which is supplied from a commercial power supply 301 to the heater 201.

The power energization control signal is input into the transistor 409. In a case where the power energization control signal instructs to supply power to the heater 201, the transistor 409 switches the triac 404 to a power energization state via the photo triac coupler 407. The triac 404 functions as a switch for supplying power from the commercial power supply 301 to the heater 201.

The zero cross detection unit 403 detects a zero cross point of AC voltage which is supplied from the commercial power supply 301. Then, the zero cross detection unit 403 inputs zero cross signal showing the detection result into the CPU 106. To efficiently heat the heater 201 at desired temperature, based on the zero cross signal 413, the CPU 106 performs phase control of the power which is supplied to the heater 201.

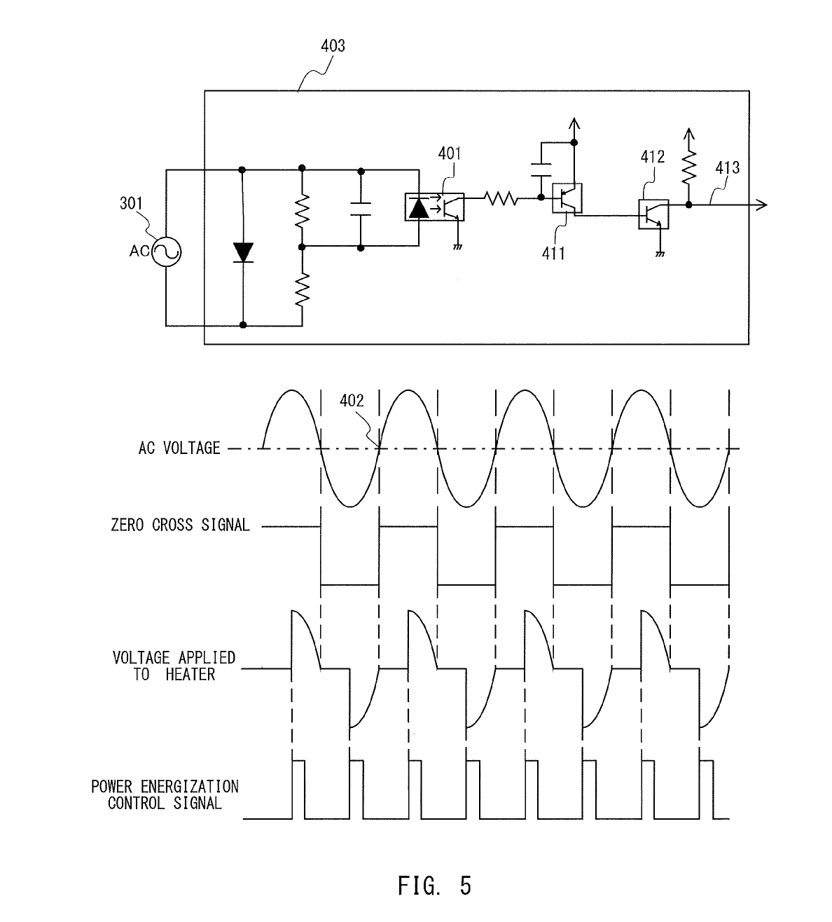

FIG. 5 is an explanatory diagram of the zero cross detection unit 403. The zero cross detection unit 403 comprises a photo coupler 401 and transistors 411 and 412. In a case where voltage is supplied from the commercial power supply 301 in a forward direction of light emitting diode incorporated in the photo coupler 401, the zero-cross detection unit 403 outputs the zero cross signal 413 in high state. In a case where voltage is supplied from the commercial power supply 301 in a reverse direction of the light emitting diode, the zero cross detection unit 403 outputs the zero cross signal 413 in low state. A falling part where the state of the zero cross signal 413 switches from the high state to the low state is a zero cross point 402.

On the basis of the zero cross point 402, the CPU 106 performs the phase control of the power which is supplied to the heater 201 defining a high section or a low section of the zero cross signal 413 as one half-wave section. At timing adapted for the power to be supplied in one half-wave, the CPU 106 outputs the power energization control signal to make the triac 404 conductive. The triac 404 turns to a non-conductive state at timing of the zero cross point. To switch the triac 404 to be conductive/non-conductive in one half-wave cycle, the CPU 106 can control the power which is supplied to the heater 201 as a phase angle of the power to be supplied. Further, by adjusting ratio of the high state and the low state of the power energization control signal with respect to the power required, the CPU 106 may control power which is supplied to the heater 201.

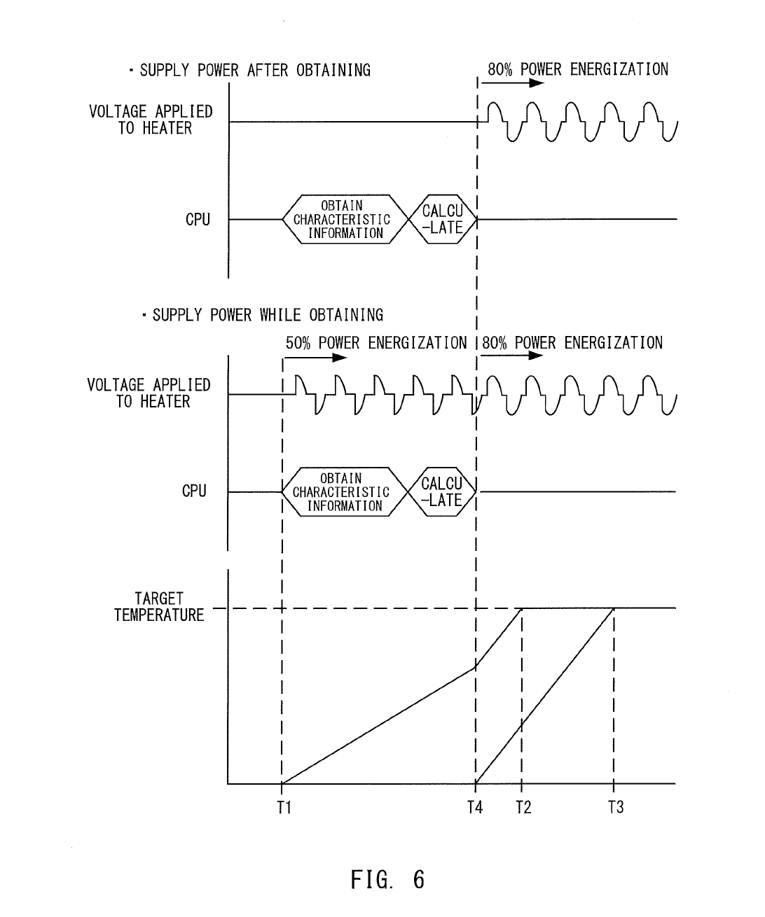

FIG. 6 is a timing chart when supplying power to the heater 201. As mentioned, when supplying power to the heater 201, in the present embodiment, the main control unit 104 obtains the characteristic information from the non-volatile memory 102 of the fixing device 101. Conventionally, the main control unit 104 obtains the characteristic information through the serial communication. Then, after completing to obtain the characteristic information, the main control unit 104 starts to supply power to the heater 201. In the present embodiment, the main control unit 104 supplies minimum power capable of supplying to the heater 201 while obtaining the characteristic information. For example, in the present embodiment, the minimum power is 50% of the power capable of supplying in one half-wave.

The conventional main control unit 104 does not instruct the power energization control unit 105 to supply power to the heater 201 from time T1 when the main control unit 104 starts to obtain the characteristic information to time T4 when the main control unit 104 completes to obtain the characteristic information. At time T4, power supply to the heater 201 is started. At time T3, the heater 201 reaches target temperature required to fix the toner image on the sheet P. From the start of obtaining the characteristic information to the reach of the heater 201 to the target temperature, time (T3-T1) is required.

In the present embodiment, the main control unit 104 starts to obtain the characteristic information at time T1. At the same time, the main control unit 104 supplies minimum power capable of supplying, by the commercial power source 301, to the heater 201. At time T2, which is earlier than time T3, the heater 201 reaches the target temperature. Thereby, from the start of obtaining the characteristic information to the reach of the heater 201 to the target temperature, time (T2-T1) is required. It means that, by starting to heat the heater 201 while obtaining the characteristic information, the main control unit 104 can make the heater 201 at the target temperature in a shorter time than before. In particular, by shortening the time by time (T3-T2), the main control unit 104 can make the heater 201 at the target temperature.

For example, as the serial communication when obtaining the characteristic information, the CPU 106 of the main control unit 104 performs I2C communication. The communication speed is 100 Kbit/s. Data amount of the characteristic information is 512 bits. In the I2C communication, the CPU 106 accesses 8-bit information at one time and about 0.8 milliseconds are required for reading. The characteristic information is 512 bits. Thereby, about 30 milliseconds are required for communication time. Further, the CPU 106 performs communication with other components of the image forming apparatus other than the fixing device 101. Thereby, considering standby time, the CPU 106 requires about 200 to 300 milliseconds for completing to obtaining the characteristic information. Thereby, in the present embodiment, it is possible to start to heat the heater 201 about 200 to 300 milliseconds earlier than before.

In the following description, the power which is supplied to the heater 201 is defined as follows, for example. The resistance value of the heater 201 is 10Ω±7%, variation in AC voltage is 85 to 115 V, and input power while the resistance value of the heater 201 is not determined is 900 W. In a case where 100% power is supplied to the heater 201 in one-half wave, variation is caused in the power, i.e., the power varies from 844 to 1777 W. Thereby, while the resistance value of the heater 201 is not determined, i.e., while the characteristic information is being obtained, the CPU 106 supplies 50% power in one half-wave. It is noted that the CPU 106 may detect the AC voltage which is supplied, suppress the variation in the AC voltage, and supply the larger power while the characteristic information is being obtained.

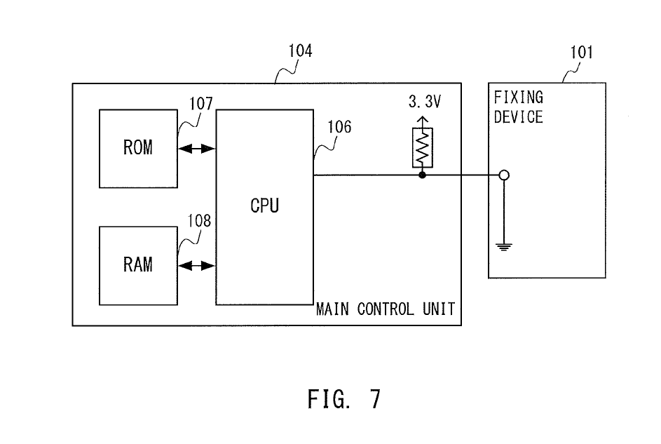

There is a case where the image forming apparatus like this can attach/detach the fixing device 101. In this case, the main control unit 104 is configured to detect attachment/detachment of the fixing device 101. This is because, every time new fixing device 101 is mounted, it is required to obtain the characteristic information of the new fixing device 101. FIG. 7 is an explanatory diagram of the configuration in which the main control unit 104 detects the attachment/detachment of the fixing device 101.

In a case where the fixing device 101 is mounted to the image forming apparatus, a mounting terminal for detecting a mounting state is connected to a ground in the fixing device 101. In this case, a low mounting signal is input into the mounting terminal of the CPU 106. In a case where the fixing device 101 is detached from the image forming apparatus, the mounting signal is pulled up by the power source in the fixing device 101 (3.3 V). In this case, a high mounting signal is input into the mounting terminal of the CPU 106. When detecting that the fixing device 101 is detached by the mounting signal while the power source is turned on, the CPU 106 turns an attachment/detachment detection flag, representing the mounting state of the fixing device, ON.

Further, other than the mounting signal, the CPU 106 may detect the mounting state of the fixing device 101 based on the detection result of the temperature detection unit 212. The CPU 106 obtains the detection result of the temperature of the heater 201 from the temperature detection unit 212 while the power source is turned on. The CPU 106 determines that the fixing device 101 is attached/detached and replaced by confirming that the temperature of the heater 201 is changed predetermined temperature or more in a predetermined time period while not energized power to the heater 201.

Further, the CPU 106 may determine the replacement of the fixing device 101 based on a comparison result obtained by, for example, reading serial ID for identifying the fixing device 101 stored in the non-volatile memory 102 and comparing serial ID stored in the RAM 108 with the serial ID read. In a case where the serial ID stored in the RAM 108 is identical to the serial ID read, the CPU 106 determines that the fixing device 101 is not replaced. In a case where the serial ID stored in the RAM 108 is not identical to the serial ID read, the CPU 106 determines that the fixing device 101 is replaced. In a case where the fixing device 101 is replaced, the CPU 106 stores the serial ID and the characteristic information of the fixing device 101 in the RAM 108. Due to this, the information stored in the RAM 108 is updated.

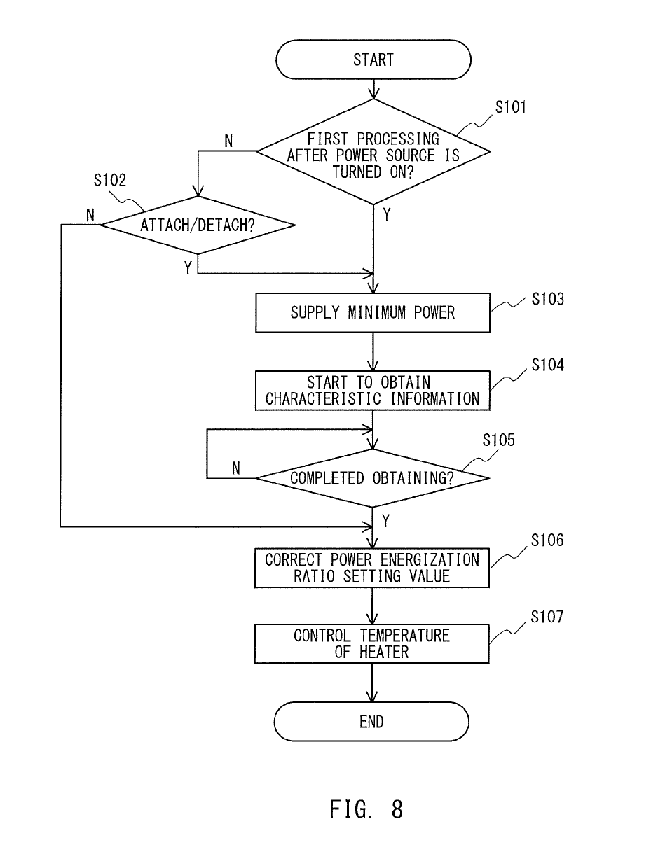

FIG. 8 is a flowchart showing temperature control processing of the heater 201 performed by the image forming apparatus as mentioned above. The processing is performed when supplying power to the heater 201 to heat the heater 201, i.e., when forming images.

The main control unit 104 determines whether it is first processing after the power source is turned on or not (Step S101). The main control unit 104 stores, for example, log of the processing performed by the image forming apparatus in the RAM 108. By confirming the log, the main control unit 104 determines whether it is the first processing after the power source is turned on or not. If it is determined that it is not the first processing after the power source is turned on (Step S101: N), the main control unit 104 determines whether attachment/detachment of the fixing device 101 to/from the image forming apparatus is performed or not (Step S102). The main control unit 104 confirms the attachment/detachment of the fixing device 101 by the attachment/detachment detection flag.

If it is determined that it is the first processing after the power source is turned on (Step S101: Y), or if the fixing device 101 is attached/detached (Step S102: Y), the main control unit 104 needs to newly obtain the characteristic information of the fixing device 101. Thereby, the main control unit 104 first supplies the minimum power to the heater 201 of the fixing device 101 (Step S103). The main control unit 104 transmits the power energization control signal to the power energization control unit 105. The power energization control signal is to supply the minimum power to the heater 201. The power energization control unit 105 performs power energization control according to the power energization control signal and starts to heat the heater 201.

After starting to supply the minimum power to the heater 201, the main control unit 104 starts to obtain the characteristic information of the fixing device 101 from the non-volatile memory 102 of the fixing device 101 (Step S104). When the main control unit 104 completes obtaining the characteristic information (Step S105: Y), the main control unit 104 updates the power energization ratio setting value according to the characteristic information (Step S106). For example, the main control unit 104 stores the characteristic information obtained in the RAM 108.

It is noted that if no attachment/detachment of the fixing device 101 is performed (Step S102: N), the main control unit 104 already obtains the characteristic information of the fixing device 101 mounted and stores the characteristic information in the RAM 108 through the previous processing. In this case, the main control unit 104 updates the power energization ratio setting value based on the characteristic information already obtained through the processing of Step S106.

The main control unit 104 supplies the power according to the updated power energization ratio setting value to the heater 201 of the fixing device 101 by the power energization control unit 105 (Step S107). The main control unit 104 transmits the power energization control signal to the power energization control unit 105. The power energization control signal is to supply the power updated according to the updated power energization ratio setting value to the heater 201. The power energization control unit 105 performs power energization control according to the power energization control signal and controls the temperature of the heater 201.

As mentioned, the image forming apparatus of the present embodiment starts to heat the heater 201 before completing to obtain the characteristic information. Thereby, as shown in FIG. 6, the image forming apparatus can shorten the heating time of the heater 201 until the heater 201 reaches the target temperature. Thereby, the image forming apparatus can promptly heat the heater 201 to the target temperature than before.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-176093, filed Sep. 7, 2015 which is hereby incorporated by reference herein in its entirety.

What is claimed is:

1. An image forming apparatus to which a fixing device, which comprises a heater and a memory for storing information relating to the heater, is detachably mounted, the image forming apparatus comprising:
a storage unit configured to store the information relating to the heater obtained from the memory of the fixing device;
an image forming unit configured to form an image on a sheet; and
a controller configured to control power to be supplied to the heater based on the information stored in the storage unit, and control the fixing device to fix the image on the sheet;
wherein the controller detects replacement of the fixing device,
wherein, in a case where replacement of the fixing device is detected, the controller reads information stored in a memory of the replaced fixing device to update the information stored in the storage unit, and
wherein, in a case where replacement of the fixing device is detected, the controller starts to supply power to the heater before completing to read the information from the memory of the replaced fixing device.

2. The image forming apparatus according to claim 1,
wherein the controller further comprises a detection unit configured to detect replacement of the fixing device.

3. The image forming apparatus according to claim 1,
wherein the controller detects replacement of the fixing device based on the information stored in the memory of the fixing device and information stored in the storage unit.

4. The image forming apparatus according to claim 3,
wherein the information stored in the storage unit includes serial ID for identifying the fixing device, and
wherein the controller detects replacement of the fixing device in a case where serial ID included in the information stored in the memory of the fixing device differs from the serial ID stored in the storage unit.

5. The image forming apparatus according to claim 1,
wherein the controller controls a power supply condition for the heater to control power which is supplied to the heater.

6. The image forming apparatus according to claim 5,
wherein, in a case where replacement of the fixing device is detected, the controller controls the power supply condition based on a predetermined power energization pattern before completing to read the information from the memory of the replaced fixing device.

7. The image forming apparatus according to claim 6,
wherein, after the information stored in the storage unit is updated, the controller changes the power energization pattern based on the updated information.

8. The image forming apparatus according to claim 5,
wherein the power energization pattern includes a first state in which power is supplied to the heater and a second state in which power is not supplied to the heater.
